(19) United States
(12) Patent Application Publication
(10) Pub. No.: US 2012/0172614 A1
(43) Pub. Date: Jul. 5, 2012

(54) METHOD FOR THE MANUFACTURE OF DIALKYL PHOSPHITES

(75) Inventors: Patrick Notté, 1300 Wavre (BE); Samuel Corentin Cogels, 1050 Ixelles (BE); David Lemin, Watermael-Boitsfort (BE)

(73) Assignee: STRAITMARK HOLDING AG, 6300 Zug (CH)

(21) Appl. No.: 13/322,420

(22) PCT Filed: May 28, 2010
(86) PCT No.: PCT/EP2010/057437

§ 371 Date: Feb. 8, 2012

(30) Foreign Application Priority Data
May 28, 2009 (EP) 09161390.1

(51) Int. Cl. C07F 9/40

(52) U.S. Cl. 558/113

(57) ABSTRACT

A method for the manufacture of dialkyl phosphites by reacting a P—O component containing from 1 to 6 P—O—P bonds in the molecule, with an alcohol and a ketal corresponding to a selected formula, said ketal will not lead to the formation of an enol structure. The level of the ketal is expressed in relation to the level of co-reactants. A preferred ketal is void of any carbon-hydrogen bonds on the α-carbon atom in the ketal structure.

This invention concerns a beneficial method for the manufacture of dialkyl-phosphites starting from P—O component containing from 1 to 6 P—O—P bonds in the molecule comprising the steps of reacting a mixture of an alcohol and the P—O, in specifically defined molar ratios, with a specific ketal reactant whereby the level of the ketal required for the conversion is related to the number of P—O—P bonds in the P—O compound. The P—O is added, simultaneously with or separately from the ketal, to a reaction medium comprising the alcohol and reacted followed by recovering the dialkyl phosphite formed in a manner known per se. The ketal reactant can be present during the reaction in either, with respect to the reaction medium, homogeneous form or heterogeneous form. In a preferred execution, the P—O is represented by liquid P₄O₆ and compounds having from 2 to 6 P—O—P bonds.

Dialkyl phosphites have been known for a long time and their importance as intermediates, among others, for synthesizing desirable compounds had been established accordingly. The art had, up to now, not offered a solution to this problem although a large variety of approaches had been investigated. CN 101250199 pertains to a method for preparing diisopropyl phosphite from PCl₃ and isopropanol. DE 4121696 describes a process for the preparation of dialkyl phosphites. The treatment of a mixture of methyl- and dimethyl phosphite with acetic anhydride and methanol in benzene resulted in a product containing a high level of dimethyl phosphite. Several publications, HU 207334, HU 199149 and HU 196817, disclose a process for the manufacture of dialkyl phosphites starting from PCl₃.

DD 108755 describes the reaction of P₄O₆ vapour and methanol vapour to thus yield a mixture of liquid monoester and gaseous diester.

U.S. Pat. No. 4,342,709 describes a process of producing diethyl phosphites by reacting an excess of triethyl phosphite with phosphorous acid. The triethyl reactant is usually added in excess of 7-10% beyond stoichiometric needs. The process starts from a strictly anhydrous phosphorous acid. To avoid negatives attached to the absorption of water, the phosphorous acid is added under inert gas purging. DD 128755 describes a continuous process for preparing dialkyl phosphites starting from phosphorus trichloride and monovalent aliphatic alcohols in the presence of an inert solvent. DOS 1 668 031 pertains to the manufacture, in high yields and purity, of dialkyl phosphites starting from primary or secondary linear or branched alcohols, having at least 5 carbon atoms, with phosphorous acid in an excess of at least 45%.

DD 116457 pertains to a continuous process for the manufacture of mono- and di-alkyl phosphites by reacting: a mixture of alcohol and alkyl phosphite or a mixture of mono- and di-alkyl phosphites to which mixture is added technical grade POD-oxide containing elementary phosphorus, while purging with technical nitrogen followed by a distillative separation of the mono- and di-alkyl phosphites formed. DD 108755 divulges a process for the continuous preparation of mixtures of mono- and di-alkyl phosphites by reacting P₄O₆ with alcohols in the gaseous phase with high yields. DD 222596 concerns a method for preparing pure alkyl- or aryl-diesters of phosphorous acid starting from a mixture of mono- and di-ester phosphites. This mixture is dissolved in an inert organic solvent and the mono-species is precipitated by leading ammonia gas through the mixture.

U.S. Pat. No. 5,344,951 describes a process for preparing di-esters of phosphorous acid whereby a phosphorous acid solution is reacted with an excess of monohydric alcohol to thus yield dihydrocarbyl phosphite. WO 2004/024742 concerns a method for the joint manufacture of diethyl phosphite and ethylchloride whereby one reacts ethanol and phosphorous trichloride in the presence of an additive from the group of tri-ethyl phosphite, diethyl phosphite and/or ethylchloride. In general, the like dialkyl phosphite preparations yield by-products including alkyl chlorides, olefins and ethers due to the presence of alcohol and HCl in the process.

The prior art unequivocally shows that the dialkyl phosphite manufacturing technology while deserving substantial technological and economical improvements has been substantially stagnant for a long time, at least had not offered any viable solution to the outstanding problems. The art technology is frequently cumbersome, time consuming, uneconomical and not adapted to actual and foreseeable commercial needs.

The term “percent” or “%” as used throughout this application stands, unless defined differently, for “percent by weight” or “% by weight”. The term “ppm” stands for “parts per million”. The terms “P₂O₃” and “P₄O₆” can be used interchangeably. The term homogeneous ketal means ketals adapted to form a single liquid phase in the reaction medium under the reaction conditions. The term heterogeneous ketal means that the ketal is substantially insoluble in the reaction medium at the reaction conditions; this insolubility can be ascertained routinely based on visible observations. The term “liquid P₄O₆” embraces neat P₄O₆ in the liquid state, solid P₄O₆ and gaseous P₄O₆, preferably liquid P₄O₆. The term “ambient” with respect to temperature and pressure generally means usually prevailing terrestrial conditions at sea level e.g. temperature is about 18° C. to 25° C. and pressure stands for 990-1050 mm Hg.

It is a major object of this invention to provide significantly improved process for the manufacture of dialkyl phosphites. Yet another object of this invention aims at providing chlorine free process for the manufacture of dialkyl phosphites. It is another object of this invention to provide a method for the manufacture of dialkyl phosphites from reactants broadly other than mixtures of mono and dialkyl phosphites e.g. pure monoalkyl phosphites. Still another aim of this invention is to provide a one-step manufacture of dialkyl phosphites starting from P—O component. Still another object herein envisages a method for the manufacture of dialkyl phosphites of improved purity and selectivity commensurate with prevailing needs. Yet another objective herein aims at providing dialkyl phosphites at economical favourable conditions. Still another object of this invention aims at providing technology which can serve for the beneficial manufacture of phosphonobutane tricarboxylic acid (PBTC).

The above and other objects of the invention can now be achieved by means of a specifically defined method of manufacture whereby P—O—P bonds containing compounds are converted into the corresponding dialkyl phosphites with the aid of an alcohol and a narrowly defined ketal reactant. In detail, the invention herein contemplates a method for the manufacture of dialkyl phosphites starting from P—O component containing from 1 to 6 P—O—P bonds in the molecule comprising the step of:

reacting a mixture of R″OH and the P—O component, expressed in molar ratios R″OH:P—O of, at least, 1:1 to 6:1

wherein R″ is selected from alkyl groups having from 1 to 20 carbon atoms in linear or branched configuration; and

a ketal having the formula:

RR′C(OA)₂

wherein A stands for C₁₋₂₀ linear or branched alkyl groups; and wherein R and R′ are selected from alkyl, aryl, alkaryl and cyclo-alkyl hydrocarbon groups, wherein R and R′ may be connected to form a ring, wherein the total number of carbon atoms in R and R′, connected and individually, is at least 4, wherein the structure of the ketone, RR′C=O being the ketal precursor, does not allow the formation of an enol structure; whereby the minimum number of mole(s) of RR′C(OA)₂ to be employed in the process, z, (which is required for the stoichiometric conversion of P—O to the dialkyl phosphite), is determined by z=−m+2n, wherein m is the number of P—O—P bonds in the P—O molecule and n is the number of P atoms in the P—O molecule; by adding the P—O simultaneously with or separately from the ketal, to a reaction medium comprising the R″OH and bringing the reaction medium to a temperature in the range of from 70° C. to 200° C. for a period of from 10 minutes to 10 hours; to thereby form the dialkylphosphite reaction product.

The preferred ketal is one which does not contain a carbon-hydrogen bond on the α-carbon atom in the ketal structure. More generally, the ketals of this invention have a chemical structure which does not allow the formation of enol structures in accordance with Bredt's Rule associated with bridged systems. Bredt's Rule states that in small bridged systems one can not, for steric reasons, have a double bond at the bridge head position. Usually this means that the ketal is void of any carbon-hydrogen bond on the a-carbon atom in the ketal structure.

The R″OH is represented by alcohols having an alkyl group of from C₁ to C₂₀, in linear or branched structure, preferably an alkyl group having from 1 to 12 carbon atoms. The R″OH is used in relation to P—O in molar ratios of from R″OH: P—O of at least 1:1 to 6:1. The ratios R″OH:P—O of 1:1 to 6:1 are related to the number of P—O—P bonds in the P—O compound. The term “at least” means that the level of R″OH can be increased to e.g. 8:1 without adversely affecting the system. Any excess of R″OH can routinely be recycled into the system and thus doesn't affect the economics of the inventive method.

In a preferred execution of this invention, the dialkylphosphite is prepared by adding P₄O₆, more preferably in liquid form, to the reaction medium simultaneously with or separately from the ketal. The reaction medium is generally the alcohol R″OH itself although a suitable solvent which is inert in relation to P—O, R″OH and the ketal, can be used optionally. Suitable solvents are preferably as follows: anisole; fluorobenzene; chlorinated hydrocarbons such as chlorobenzene, tetrachloroethane, tetrachloroethylene; polar solvents like sulfolane, diglyme, glyme, diphenyl oxide, polyalkylene glycol derivatives with capped OH groups such as OR where R is a low alkyl group; aliphatic hydrocarbons such as hexane, heptane, cyclohexane; non-cyclic ethers like dibutyl ether, diisopropyl ether, and dipentyl ether; cyclic ethers like tetrahydrofuran and dioxane; aromatic hydrocarbons like toluene, xylene; organic nitriles like acetonitrile; silicon fluids like polymethylphenyl siloxane or mixtures thereof.

The P₄O₆ can be represented by a substantially pure compound containing at least 85%, preferably more than 90%; more preferably at least 95% and in one particular execution at least 97% of the P₄O₆. While tetraphosphorus hexa oxide, suitable for use within the context of this invention, can be manufactured by any known technology, in preferred executions the hexa oxide can be prepared in accordance with the method of WO 2009/068636 and/or PCT/EP2009/064988, entitled “Process for the manufacture of P₄O₆ with improved yield”. In detail, oxygen, or a mixture of oxygen and inert gas, and gaseous or liquid phosphorus are reacted in essentially stoichiometric amounts in a reaction unit at a temperature in the range from 1600 to 2000 K, by removing the heat created by the exothermic reaction of phosphorus and oxygen, while maintaining a preferred residence time of from 0.5 to 60 seconds followed by quenching the reaction product at a temperature below 700 K and refining the crude reaction product by distillation. The hexa oxide so prepared is a pure product containing usually at least 97% of the oxide. The P₄O₆ so produced is generally represented by a liquid material of high purity containing in particular low levels of elementary phosphorus, P₄, preferably below 1000 ppm, expressed in relation to the P₄O₆ being 100%. The preferred residence time is from 5 to 30 seconds, more preferably from 8 to 30 seconds. The reaction product can, in one preferred execution, be quenched to a temperature below 350 K.

The term “liquid P₄O₆” embraces, as spelled out, any state of the P₄O₆. However, it is presumed that the P₄O₆ participating in a reaction at a temperature of from 70° C. to 200° C. is necessarily liquid or gaseous although solid species can, academically speaking, be used in the preparation of the reaction medium.

The P—O component can be represented by P₄O₆, or partially hydrated species thereof, containing from 1 to 6 P—O—P bonds in the molecule. Examples of suitable species of the P—O component include: pyrophosphorous acid, H₄P₂O₅, containing one P—O—P bond; P₄O₆ containing six P—O—P bonds; and partially hydrated species thereof containing 2, 3, 4 and 5 P—O—P bonds respectively. Partially hydrated P₄O₆ can lead to hydrolysis products containing 2, 3, 4 or 5 P—O—P bonds. For reasons of convenience and operational expertise, the P—O component is preferably represented by P₄O₆ of high purity containing very low levels of impurities, in particular elemental phosphorus, P₄, at a level below 1000 ppm, usually below 500 ppm and preferably not more than 200 ppm, expressed in relation to the P₄O₆ being 100%. The P—O component can be represented by uniform ingredients having e.g. a uniform number of P—O—P bonds or by mixtures having a distribution of P—O—P bonds as may occur in partially hydrated species of P₄O₆. Obviously, in such case the number of P—O—P stands for an average number of P—O—P bonds. Suitable P—O can also be prepared starting from PCl₃ by partial hydrolysis, or by reacting PCl₃ and phosphorous acid or by reacting P₄O₆ and phosphorous acid or by partial hydrolysis of P₄O₆. The P—O can be represented by mixtures/combinations of different reagents e.g. PCl₃, phosphorous acid and water subject to the presence of at least one P—O—P bond in the molecule. The level of water to be employed is limited (in molar terms) to 4 H₂O or less per P₄O₆. In the event a chlorine containing starting materials, e.g. PCl₃ and combinations thereof, are used the level of chlorine shall be kept below 1000 ppm, usually below 500 ppm, preferably below 200 ppm, expressed in relation to the P—O material being 100%.

Ketals have been known for a long time and are commodity materials. Ketals are generally formed by reaction of the corresponding ketones with alcohols in the presence of acid catalysts. As the reaction is reversible the equilibrium must be shifted, usually by removal of water. This can be done by azeotropic distillation, ordinary distillation, or the use of drying agents such as molecular sieve. Although many ketals have been synthesized in good yields from cyclic ketones, alcohols and acid catalysts, higher yields and conversions have been obtained by transacetalation whereby the ketone is reacted with e.g. an ortho ester in the presence of an acid catalyst. This approach can also be used to convert ketals prepared from low molecular weight alcohols by reaction with a higher molecular weight alcohols and distillation of the low molecular weight alcohol. Similar procedure can be followed up for the conversion of polymer supported ketones such as for example phenyl-CO—; naphthyl-CO— and t-butyl CO grafted onto styrene cross-linked with divinyl benzene to the corresponding ketal.

Preferred ketals for use herein are those wherein the A group is represented by alkyl groups having from 1 to 12 carbon atoms and wherein the ketal precursors i.e. the ketone, RR′C=O, does not contain any carbon-hydrogen bond on the a-carbon atoms; in even more preferred species, R and R′ in the ketal are selected from naphthyl, phenyl, t-butyl or wherein the ketal precursor is selected from fluorenone, anthraquinone or 9,10-phenanthrene quinone; in another preference the ketal precursor is selected from phenyl-CO—; naphthyl-CO—; or t-butyl-CO— grafted onto polyphenyl resins, e.g. styrene polymer crosslinked with divinyl benzene.

The reaction in accordance with this invention is conducted in a manner routinely known in the domain of the technology. As illustrated in the experimental showings, the method can be conducted by combining the essential reaction partners and heating the reaction mixture to a temperature usually within the range of from 70° C. to 200° C., more preferably 100° to 160° C., in particular 120 to 150° C. The upper temperature aims at preventing any substantial undue decomposition of the reactants or of the intermediates formed in these reactions. It is understood and well known that the decomposition temperature of the reaction partners can vary depending upon physical parameters, such as pressure and the qualitative and quantitative parameters of the ingredients in the reaction mixture.

The inventive reaction can be conducted at ambient, or reduced, pressure and, depending upon reaction temperature, under distillation of potential excess alcohol and alcohol formed during the reaction. The duration of the reaction can vary from virtually instantaneous, e.g. 10 minutes, to an extended period of e.g. 10 hours. In one method set up, the P—O, the alcohol and the ketal are added to the reactor followed by heating this mixture gradually to a temperature of from 70° to 150° C. This reaction can be carried out under ambient, or reduced, pressure with or without distillation of the alcohol. In preferred executions, excess alcohol will be distilled, possibly under vacuum prior to the addition of the ketal and preferably of a solvent.

In another operational arrangement, the reaction can be conducted in a closed vessel under autogeneous pressure built up. In this method, the reaction partners, in total or in part, are added to the reaction vessel at the start. In the event of a partial mixture, the additional reaction partner can be added gradually, as soon as the effective reaction temperature has been reached. This set up is most advantageous inasmuch as it allows the use of low boiling solvent.

In yet another operational sequence, the reaction can be conducted in a combined distillation and pressure arrangement. Specifically, the reaction vessel containing the reactant mixture is kept under ambient pressure at the selected reaction temperature. The mixture is then, possibly continuously circulated through a reactor operated under autogeneous (autoclave principle) pressure build up thereby gradually adding the additional reaction partners in accordance with needs. In the event the ketal is heterogeneous, the reaction will preferably proceed in the autogeneous reactor. The reaction is substantially completed under pressure and the reaction mixture then leaves the closed vessel and is recycled to the reactor where alcohol distillation can occur.

The foregoing process variables thus show that the reaction can be conducted by a variety of substantially complementary arrangements. The reaction can thus be conducted as a batch process by heating the initial reactants in a (1) closed vessel under autogeneous pressure built up, or (2) under distillation, to a temperature preferably in the range of from 70° C. to 150° C. In a particularly preferred embodiment, the reaction is conducted in a closed vessel at a temperature in the range of from 100° C. to 150° C. coinciding particularly with the gradual addition of residual ingredients.

In another approach, the reaction is conducted as a continuous process, possibly under autogeneous pressure, whereby the reactants are continuously injected into a reaction mixture at a temperature preferably in the range of from 70° C. to 150° C.

In yet another arrangement, the method can be represented by a semi-continuous set-up whereby the reaction is conducted continuously whereas preliminary reactions between part of the components can be conducted batch-wise e.g. between P—O and alcohol.

The dialkyl phosphite reaction products can, if needed, be recovered from the reaction product by conventional means including, in particular, vacuum distillation.

The dialkyl phosphites can be used as intermediates, e.g. for beneficially synthesizing compounds which were known to be difficult to make. As an example, 2-phosphonobutyl-1,2,4-tricarboxylic acid can be made starting from dialkylphosphites as follows:

1: reacting methyl phosphite with methylmaleate; followed by

2: reacting the system resulting from 1: with methyl acrylate in the presence of sodium methoxide; followed by

3: hydrolysing the ester groups formed under 2: with water in the presence of hydrochloric acid.

Accordingly, in a further aspect of the invention there is provided a process for preparing 2-phosphonobutyl-1,2,4-tricarboxylic acid by preparing dimethyl-phosphite according to the method of the invention and further conversion as described above.

The invention is further illustrated by the following examples without limiting it thereby.

### EXAMPLES

### Example 1

5.13 g of benzophenone dimethyl acetal (94% pure, 0.021 mol) and 5 mL of 1,4-dioxane were added to 3 mL of a MMP-DMP mixture having a composition of P-containing species of about 50 mole % of DMP; 45 mole % of MMP and 5 mole % of phosphorous acid, in a round-bottom flask equipped with a reflux condenser and under nitrogen. The mixture was heated to reflux under magnetic stirring for three hours. After cooling ³¹P NMR analysis showed 63 mole % of DMP; 33 mole % of MMP and 2.3 mole % of phosphorous acid.

### Example 2

5.13 g of benzophenone dimethyl acetal (94% pure, 0.021 mol) and 5 mL of toluene were added to 3 mL of a MMP-DMP mixture having a composition of P-containing species of about 50 mole % of DMP; 45 mole % of MMP and 5 mole % of phosphorous acid, in a round-bottom flask equipped with a reflux condenser and under nitrogen. The mixture was heated to reflux under magnetic stirring for three hours. After cooling ³¹P NMR analysis showed 62 mole % of DMP; 33 mole % of MMP and 2 mole % of phosphorous acid.

### Example 3

2.5 g of benzophenone dimethyl acetal (94% pure, 10 mmole) and 2.5 mL of 1,4-dioxane were added to 1.5 mL of a MMP-DMP mixture having a composition of P-containing species of about 50 mole % of DMP; 45 mole % of MMP and 5 mole % of phosphorous acid, in a sealed tube. The tube was heated in an oven at 140° C. for 2.5 hours. After cooling a sample was analysed by ³¹P NMR, which showed 83 mole % of DMP; 10 mole % of MMP and 0.2 mole % of phosphorous acid.

### Example 4

2.5 g of benzophenone dimethyl acetal (94% pure, 10 mmole) and 2.5 mL of 1,4-dioxane were added to 1.5 mL of a MMP-DMP mixture having a composition of P-containing species of about 50 mole % of DMP; 45 mole % of MMP and 5 mole % of phosphorous acid, in a sealed tube. The tube was heated in an oven at 140° C. for 5.5 hours. After cooling a sample was analysed by ³¹P NMR, which 87 mole % of DMP; 5 mole % of MMP, phosphorous acid was not detected.

### Example 5

2.5 g of benzophenone dimethyl acetal (94% pure, 10 mmole) and 7.5 mL of 1,4-dioxane were added to 1.5 mL of a MMP-DMP mixture having a composition of P-containing species of about 50 mole % of DMP; 45 mole % of MMP and 5 mole % of phosphorous acid, in a sealed tube. The tube was heated in an oven at 140° C. for 5.5 hours. After cooling a sample was analysed by ³¹P NMR, which showed 92 mole % of DMP; 6 mole % of MMP; phosphorous acid was not detected.

### Example 6

6.84 g of benzophenone dimethyl acetal (94% pure, 27 mmole), 0.10 g of methanesulfonic acid (0.05 eq. to MMP) and 30 mL of 1,4-dioxane were added to 4 mL of a MMP-DMP mixture having a composition of P-containing species of about 50 mole % of DMP; 45 mole % of MMP and 5 mole % of phosphorous acid, in an autoclave. The reactor was heated to 140° C. in 2 hours and then kept for another 3 hours at that temperature. After cooling a sample was analysed by ³¹P NMR, which showed 91 mole % of DMP; 6 mole % of MMP; phosphorous acid was not detected.

1. A method for the manufacture of dialkyl phosphites starting from a P—O component containing from 1 to 6 P—O—P bonds in the molecule comprising the step of:
a) reacting a mixture of R″OH and the P—O component, expressed in molar ratios R″OH : P—O of, at least, 1:1 to 6:1
wherein R″ is selected from alkyl groups having from 1 to 20 carbon atoms in linear or branched configuration; and
a ketal having the formula:
RR′C(OA)₂
wherein A stands for C₁₋₂₀ linear or branched alkyl groups; and wherein R and R′ are selected from alkyl, aryl, alkaryl and cyclo-alkyl hydrocarbon groups, wherein R and R′ may be connected, wherein the total number of carbon atoms in R and R′, connected and individually, is at least 4, wherein the structure of the ketone, RR′C=O, being the ketal precursor, does not allow the formation of an enol structure; whereby the minimum number of mole(s) of RR′C(OA)₂ to be employed, z, is determined by z=−m+2 n, wherein m is the number of P—O—P bonds in the P—O molecule and n is the number of P atoms in the P—O molecule;
by adding the P—O simultaneously with or separately from the ketal, to a reaction medium comprising the R″OH and bringing the reaction medium to a temperature in the range of from 70° C. to 200° C. for a period of from 10 minutes to 10 hours; to thereby form the dialkylphosphite reaction product.

2. The method in accordance with claim 1, wherein the ketal is void of any carbon-hydrogen bonds on the α-carbon atom in the ketal structure.

3. The method in accordance with claim 1, wherein the P—O is represented by liquid P₄O₆.

4. The method in accordance with claim 1, wherein the ketal is homogeneous with respect to the reaction medium and R and R′ are selected from naphthyl, phenyl and t-butyl.

5. The method in accordance with claim 1, wherein the RR′C(OA)₂ precursor is selected from fluorenone, anthraquinone, and 9,10-phenanthrene quinone.

6. The method in accordance with claim 1, wherein the ketal is heterogeneous, with respect to the reaction medium and is prepared from polyphenyl resins grafted with a phenyl-CO—, naphthyl-CO— or t-butyl-CO—, which polyphenyl resins comprise (co)polymers of styrene ethyl-vinyl benzene and α-methyl styrene which (co)polymers can be cross-linked with di-vinyl benzene.

7. The method in accordance with claim 1, wherein A is represented by linear or branched C₁₋₁₂-alkyl groups.

8. The method in accordance with claim 1, wherein the P—O is added to the reaction medium containing the R″OH and the ketal.

9. The method in accordance with claim 1, wherein the P—O is P₄O₆, and contains less than 1000 ppm of elemental phosphorus, P₄, expressed in relation to P₄O₆ being 100%.

10. The method in accordance with claim 1, wherein the alkyl groups in the alcohol, R″OH, and A in the ketal are identical.

11. The method in accordance with claim 1, wherein the molar ratio of R″OH:P—O is in the range of from 1:1 to 8:1.

12. The method in accordance with claim 1, wherein the P—O is added to the reaction medium containing water in a molar level of 4 or less H₂O per P—O.

13. The method in accordance with claim 1, wherein the alkyl group, R″, in the alcohol has from 1 to 8 carbon atoms.

14. The method in accordance with claim 1, wherein the reaction is conducted for a period of 15 minutes to 6 hours at a temperature from 70° C. to 150° C.

15. The method in accordance with claim 1 wherein the P—O compound is prepared starting from PCl₃, and contains less than 400 ppm of chlorine, expressed in relation to the P—O compound (100%).

16. The method in accordance with claim 15, wherein the dialkylphosphite formed contains less than 100 ppm, preferably less than 20 ppm, of chlorine expressed on the basis of the dialkyl phosphite (100%).
